(19) United States
(12) Patent Application Publication
(10) Pub. No.: US 2005/0028136 A1
(43) Pub. Date: Feb. 3, 2005

(54) System and method for generating an executable procedure

(76) Inventor: Ronald Craig Woodley, Altoona, PA (US)

Correspondence Address: Alexander J. Burke;Intellectual Property Department, 5th Floor, 170 Wood Avenue South, Iselin, NJ, 08830, US

(21) Appl. No.: 10/805,725

(22) Filed: Mar. 22, 2004

Related U.S. Application Data
(60) Provisional application No. 60/491,643, filed on Jul. 31, 2003.

(51) Int. Cl. G06F 9/44; G06F 15/00; G06F 12/00

(52) U.S. Cl. 717/110; 715/503; 707/200

(57) ABSTRACT

A system and method is disclosed for generating an executable procedure, the system comprising a repository including spreadsheet representative data including stored data elements that determine characteristics of an executable procedure. The system further includes an executable application for processing the spreadsheet representative data to provide an executable procedure with characteristics determined by the data elements and for use in processing data using the data elements and a command processor for initiating execution of the executable procedure in response to a user command.

### CROSS REFERENCE TO RELATED APPLICATIONS

This is a non-provisional application of provisional application Ser. No. 60/491,643 by Ronald C. Woodley filed Jul. 31, 2003.

### 1. FIELD OF THE INVENTION

The present invention relates to improved methods and systems for using a spreadsheet to generate an executable procedure having characteristics defined by the spreadsheet data.

### 2. BACKGROUND OF THE INVENTION

As is well known, spreadsheets are still one of the most successful software application types. Most people use spreadsheets to perform accounting tasks, to make budgets, to track project, cash-flow analysis, and presentations. In addition to number crunching, spreadsheets which are similar in data structure to database tables, are suitable for management of relatively small-sized data. One type of data that lends itself to such a structure is the data that is periodically published by the Federal Government which comprises updates to factors for calculating Medicare PPS accounts receivable (A/R) amounts. The factors include, for example, “Metropolitan Statistical Area Wage Indexes”, “Standard PPS Rate Adjustment”, “Labor Factor”, “LUPA threshold” and so on. When updates to these factors are published by Medicare Services, typically in the Federal Register, they need to be distributed to users, applied to the user application database, and have the derived data verified against the updated reference data. Typically, an intermediary organization writes “Structured Query Language”, or “SQL” scripts and provides the SQL scripts to the users to apply the updates to the user application database. As is well known, SQL is an industry-standard data base query language. Although very powerful, a drawback associated with using SQL, from the user's perspective, is that it is difficult to learn and use. Unlike a typical executable program (i.e., .exe) that runs on a user computer without assistance, in the case of SQL scripts a user is required to have some minimum facility in running these types of scripts. From the point of view of the entity writing the SQL scripts, the process is time-consuming, error-prone and labor intensive.

Accordingly, it is desirable to provide a system and method that utilizes the data structure of a spreadsheet that overcomes the drawbacks of using SQL scripts, or similar constructs, to distribute data, such as the data published in the Federal Register.

### SUMMARY OF THE INVENTION

The inventor has recognized the use of spreadsheets in combination with an executable application to overcome the afore-mentioned shortcomings of the prior art. The present invention uses spreadsheets to generate an executable procedure (.exe) having characteristics defined by the spreadsheet data.

The present invention provides a system and method for providing a self-contained stand-alone executable procedure (.exe) of executable instructions generated from an executable application that uses spreadsheet data as input. The spreadsheet data is used to determine characteristics of the executable procedure which may include, for example, programming language structural features, the structure of sub-procedures in the executable procedure and a process performed by a sub-procedure in the executable procedure. The invention has general applicability to any data transmission application in which it is desired to transmit data quickly from one entity to another in a manner that is neither labor intensive nor error prone.

A system for generating an executable procedure comprises: a repository including spreadsheet representative data including stored data elements determining characteristics of an executable procedure; an executable application for processing the spreadsheet representative data to provide an executable procedure with characteristics determined by the data elements and for use in processing data using said data elements; and a command processor for initiating execution of the executable procedure in response to user command.

### BRIEF DESCRIPTION OF THE DRAWINGS

Referring now to the drawings in which like reference numbers represent corresponding parts throughout, where:

FIG. 1 is a block diagram providing a structural overview of one system configuration 100 in which an embodiment of the invention may be used;

FIG. 2a shows a spreadsheet, shown in partial view, which includes updates to factors for calculating Medicare PPS A/R amounts;

FIG. 2b shows a spreadsheet, shown in partial view, in which shows further updates to factors for calculating Medicare PPS A/R amounts;

FIG. 3 shows an overview of operational steps in flow diagram form, of an embodiment of a method of generating a standalone executable procedure (.exe) from an executable application that uses spreadsheet data as input;

FIG. 4 is a more detailed flowchart of Act 315 of the flowchart of FIG. 3;

FIG. 5 are flow diagrams illustrating how a user applies the updates to the factors to the user's database in accordance with the prior art (left hand side flowchart) and the invention (right hand side flowchart);

FIG. 6 is a pop-up window that is displayed to a user upon running the stand-alone executable procedure (.exe) whenever the current system date of the user's computer is determined to be greater than thirty days past the latest effective date of the supplied updates to the factors;

FIG. 7 is a display image window of an introductory or “home” screen that is shown to a user upon loading the stand-alone executable procedure of the invention; and

FIG. 8 is a display image window of a datasource selection screen that is shown to a user in response to the user pressing the “OK” icon in FIG. 7.

### DETAILED DESCRIPTION OF THE INVENTION

The present invention is directed to the use of spreadsheets (i.e., spreadsheet data) and an executable application to produce a stand-alone executable procedure (.exe). The executable application is configured to parse data elements included in one or more spreadsheet files to generate coding (programming) statements in a high level programming language. In accordance with the principles of the invention, the coding statements determine certain characteristics of the executable procedure (.exe). For example, the characteristics of the (.exe) may include programming language structural features, the structure of sub-procedures in the executable procedure and a process performed by a sub-procedure in the executable procedure.

The invention is described hereafter in the non-limiting context of a healthcare network in which factors for calculating Medicaire PPS accounts receivable (A/R) amounts are periodically updated by the government and need to be applied to user application databases. Due to the frequency and number of updates to the government supplied data, it is difficult for users to ensure that the required changes have been made. The present invention overcomes this and other drawbacks through use of an executable application which uses spreadsheet data as input to generate a stand-alone executable procedure (.exe) to facilitate calculating updates to the Medicaire PPS accounts receivable (A/R) amounts.

In overview, in accordance with the principles of the invention, an intermediate entity enters the government mandated updates as they are published into a spreadsheet application, e.g., Microsoft Excel™. Using an executable application and the provided updates, a stand-alone executable procedure (.exe) is created which can either be delivered to end users to update their respective databases or downloaded from a central site, belonging to the intermediate entity, to facilitate proper calculation of Medicaire PPS (A/R) amounts in accordance with the updated factors. It should be recognized, however, that the invention has broader applicability to any situation in which updates are provided from one entity to another in a quick, reliable and repeatable manner that is neither labor intensive nor error prone.

The system and method of the invention provides such a quick, reliable and repeatable tool. Moreover, the invention further provides a number of specific advantages over prior art systems. Specifically, the system and method of the invention provides a self-contained executable procedure (.exe) that is small in size and easily distributed to users to apply the updates contained therein. The self-contained executable procedure (.exe) provides reconciliation capabilities which relate to providing an end user with the ability to decide which adjustments to process and which to ignore. A further specific advantage provided by the invention is that the self-contained executable procedure (.exe) makes few if any demands on a user's computer skills to implement the updates.

The disclosed elements to be described herein may be comprised of hardware portions (e.g., discrete electronic circuitry), software portions (e.g., computer programming), or any combination thereof. The system according to the invention may be implemented on any suitable computer running either UNIX, Windows NT, Windows 2000 or Windows XP. Obviously, as technology changes, other computers and/or operating systems may be preferable in the future. The system as disclosed herein can be implemented by a programmer, using commercially available development tools.

An exemplary embodiment of the executable application of the invention is a script for generating programming language code in the C++ programming language. Other embodiments may generate programming language code in other computer language implementations, which include but are not limited to: Java, HTML, XML and SGML.

It is noted that the term “module” as utilized herein in the context of “executable procedure” may refer to a collection of routines, subroutines and data structures thereof that perform particular tasks or which can implement a particular abstract data type. Thus, a “module” may be configured as a software module. Such a module may comprise at least two portions or functions. First, a module may include an interface, that lists the variables, constants, data types, routines and subroutines that may be accessible by other modules, routines, or subroutines. Second, a module may include an implementation, which is generally private (i.e., accessed by that module) and which includes a source code that actually may implement the routines, subroutines, and/or data types within the module. The term “module” is well known in the art and thus can refer to a software module and/or a self-contained module of data and may be implemented strictly through software and/or in association with a physical hardware device.

One of skill in the art can appreciate that the display image windows illustrated in the figures for the embodiments of the present invention represent one possible arrangement and that other arrangements may be used which may include several image windows in place of one image window illustrated in the figures, or conversely one image window to represent several image windows, or different image window arrangements.

A significant on-going problem faced by home health agencies (HHA) is the collection and reporting of data on the patients of the HHAs. The healthcare industry operates in accordance with a prospective payment system (PPS) which uses a standardized assessment instrument known as the Outcome and Assessment Information Set (OASIS). OASIS data is used to accurately monitor home health care quality and determines payments for individual patients. OASIS gives the center for medical services (CMS) and home health agencies (HHAs) a single data system that provides systematic and continuous monitoring of a patient, essential to improving patient outcomes. The PPS operates by establishing a standard fee, based on the average cost of caring for individuals found within similar diagnostic related groups, which is paid to a healthcare provider.

In accordance with federal government guidelines, an OASIS assessment is periodically performed for each patient in the user database, typically every sixty days. The OASIS assessments are scored from which an intermediate A/R calculation is made along with other factors for calculating Medicare PPS A/R amounts including; an MSA wage index, a standard PPS rate, a labor factor, a non-labor factor, and a rural standard rate adjustment. These intermediate values, and any A/R amounts derived from them need to be updated whenever the factors are updated by the Federal Government, which is currently done semi-annually, in April and in October. When these updates are published in the Federal Register they need to be distributed to the home health agencies (HHAs), via intermediaries to be applied to the databases of the HHAs to compute updated A/R amounts. Intermediaries presently provide the updates to the factors to the HHAs by writing and running SQL scripts. As discussed in the background, writing SQL scripts is time-consuming, error-prone, labor intensive and requires advanced computer skills. A further drawback is that writing such scripts does not verify the consistency of existing data in the HHAs databases. The present invention overcomes these and other drawbacks by providing a new and useful method and system for generating an executable procedure (.exe) from an executable application that uses spreadsheet data as input.

In accordance with the method of the invention, the data elements (i.e., the data entered into the respective cells) of a spreadsheet are utilized by an executable application to determine characteristics of an executable procedure (.exe). The characteristics may include, for example, programming language structural features of the executable procedure, the structure of sub-procedures in the executable procedure and a process performed by a sub-procedure in the executable procedure.

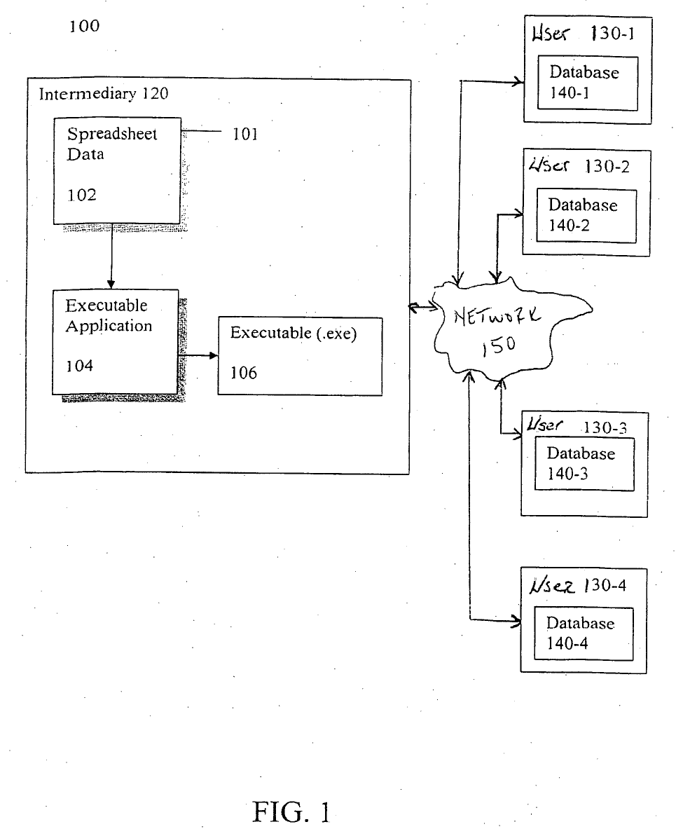

FIG. 1 is a block diagram providing a structural overview of one system configuration 100 in which an embodiment of the invention may be used. In general, an intermediary (i.e., distribution entity) 120 is communicatively coupled through a network 150 to a plurality of users 130-1 . . . , 130-4, four of which are shown. It is noted, however, that embodiments are not limited to this example context, and a practical system may have hundreds of users 130. In implementations of the present invention, a self-contained executable procedure 106 may be provided to the users 130 by publication on a dedicated web server (not shown) of the intermediary 120 for retrieval by the users 130 over network 150. Alternatively, the self-contained executable procedure 106 may be mailed to the users 130 on CD or other removable media.

An individual user 130 may be, for example, a workstation, personal computer, or any other end station data processor. An individual user 130 may also be a programmatic process that forms a part of a larger computer system or application program. An individual user 130, in the exemplary embodiment, comprises a hardware platform operated by a user, e.g., in the exemplary context, a home health agency (HHA). Network 150 is any network that can carry data communications between users 130 and intermediary 120. Network 150 may be a direct electronic connection of user 130 and intermediary 120; a local area network; a wide area network; the Internet; a combination of a an access network, a service provider network, and one or more internetworks; or any combination of the foregoing.

Entity 120 in the exemplary context is a private business enterprise having the responsibility of collecting government mandated updates to the factors for calculating Medicare PPS A/R amounts as they are published and distributing the updates to users in a timely manner.

With continued reference to FIG. 1, the systems and methods disclosed herein relate to the use of a spreadsheet file 101 including spreadsheet data 102 which is provided as input to an executable application 104, from which the executable application 104 generates and outputs a stand-alone, self-contained, executable procedure (.exe) 106 for distribution from the intermediary 120 to the plurality of users 130. A feature of the executable procedure (.exe) 106 is that it includes characteristics determined by the spreadsheet data 102.

In accordance with the principles of the invention, the executable program 106 generated by the executable application 104 updates (i.e., replaces) prior corresponding factors in one or more databases 140 of the users 130 with updated factors. In the exemplary embodiment, the factors relate to calculating Medicare PPS A/R amounts.

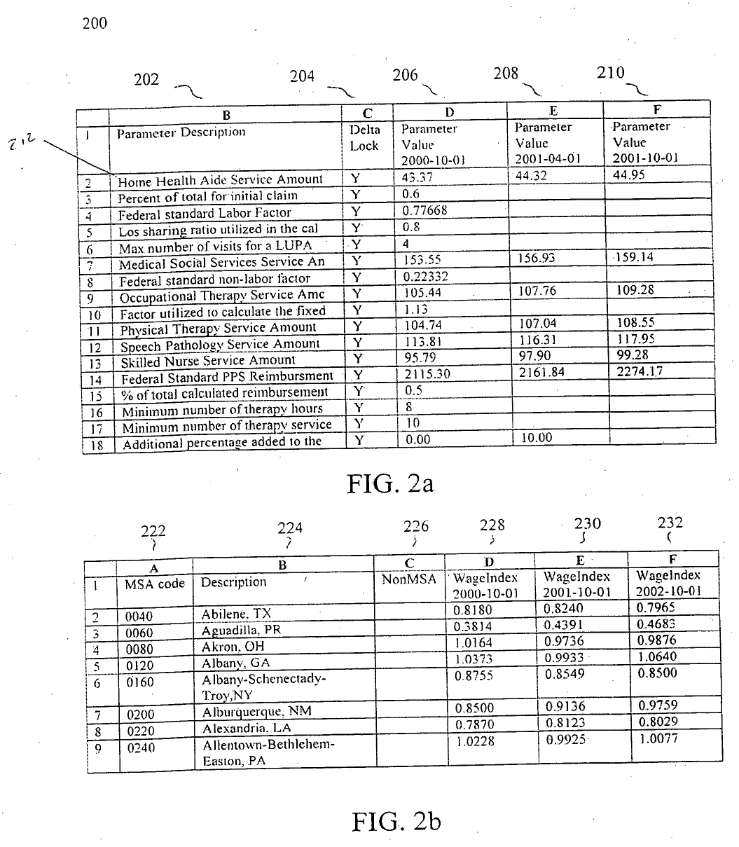

FIG. 2a shows a spreadsheet 200 (shown in partial view) in which column B 202, entitled “Parameter Description”, of the spreadsheet lists those factors, described above, which are intended to replace a prior corresponding factor of a user's database 140. The factors are used to compute updated Medicare PPS A/R (Accounts Receivable) amounts. Column C 204 is a “Y/N” indicator that indicates whether a user is allowed to modify the associated factor identified in column B 202, a “Y” indicates that a user is not allowed to make a modification. Columns D, E and F of the spreadsheet 200, indicated by reference numerals 206, 208 and 210 respectively, include government mandated updates to the factors for calculating Medicare PPS A/R amounts. Presently, updates to the factors are published by the Federal Government biannually in the Federal Register. For example, Column D lists updates to the factors published by the Federal Government for the period Oct. 1, 2000, Column E lists updates for the period Apr. 1, 2001 and Column F lists updates for the period Oct. 1, 2001.

FIG. 2a represents a partial listing of the factors used to provide updates to the user databases 140. For example, with reference now to Column D, the first factor in the parameter description listing, “Home Health Aid Service Amount”, indicated by reference numeral 212, has an associated data value of “43.37” (see cell D-2) for the update period Oct. 1, 2000, a data value of “44.32” (see cell E-2) for the update period Apr. 1, 2001 and a data value of “44.95” (see cell F-2) for the update period Oct. 1, 2001. Additional factors are now described with reference to FIG. 2b.

FIG. 2b shows another portion of the same spreadsheet 200 (shown in partial view), to illustrate an additional factor, “MSA” which is another factor used to calculate Medicare PPS A/R amounts. The “MSA” parameter is listed separately from the parameters listed in FIG. 2a as it includes multiple values to reflect different wageindex values for different regions of the country.

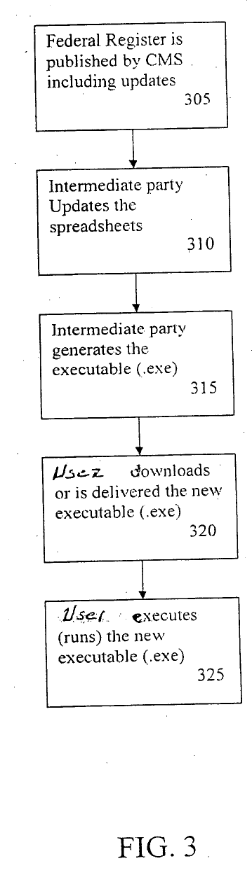

Referring now to FIG. 3, there is shown an overview of operational steps in flow diagram form, of an embodiment of a method of generating a standalone executable procedure (.exe) 106 from an executable application 104 that uses spreadsheet data 102 as input such that the stored data elements of the spreadsheet 101 determine characteristics of the executable procedure (.exe) 106.

At Act 305, the Federal Register is published by CMS to include the latest updates to the factors used to calculate Medicare PPS A/R amounts.

At act 310, an intermediary party 120 (see FIG. 1), records the most recent updates to factors published in the Federal Register as spreadsheet data 102 in a spreadsheet program 101 such as Microsoft™ Excel™.

At act 315, an executable procedure (module) 106 is generated from an executable application 104 that uses the spreadsheet data 102 as input.

At act 320, the newly generated executable (module) 106 is either published or distributed (e.g., by mail on a CD or other removable media) by the intermediary party 120.

At act 325, the users 130 download and execute the newly created executable procedure (.exe) 106 to update the factors in the user's respective databases 140.

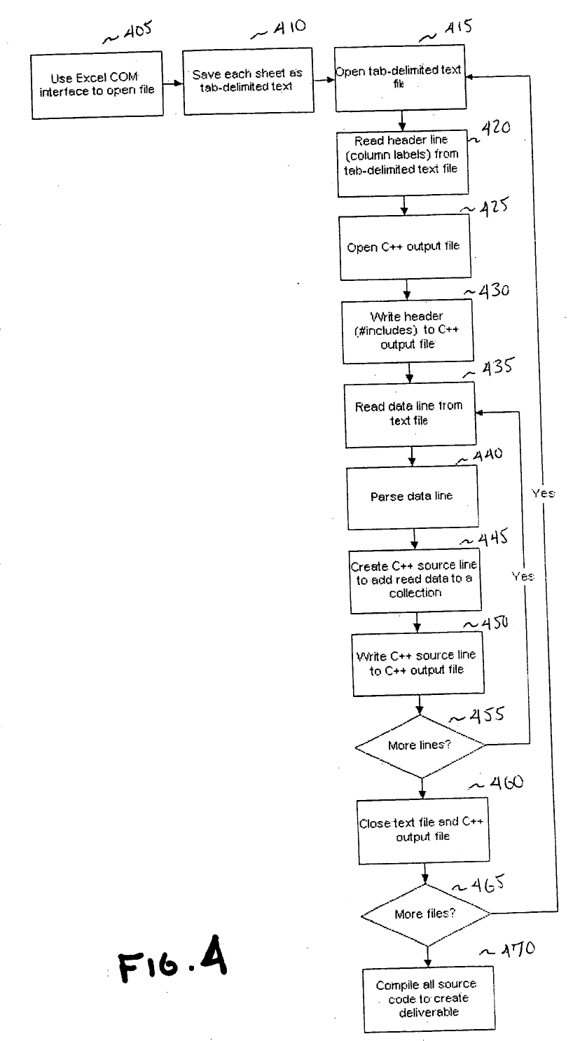

FIG. 4 is a more detailed flowchart of act 315 of the flowchart of FIG. 3 which is directed to a process by which the executable application 104 generates the executable procedure (.exe) 106 using spreadsheet data 102 as input.

At act 405, using a spreadsheet interface module, such as Microsoft™ Excel™ COM, a spreadsheet file 101 containing the updates to the factors is opened by the executable application 104.

At act 410, the various sheets of the spreadsheet file 101 containing factor updates are exported and saved as tab-delimited text and stored in a tab-delimited text file.

At act 415, the tab-delimited text-file is opened.

At act 420, the header line (i.e., column labels) are read from the tab-delimited text file. For example, referring to FIG. 2a, the column labels refer to “Parameter Description” 202, “DeltaLock” 204 and so on.

At act 425, a C++(or other high level language type program) output file is opened.

At act 430, the header information is written to the C++ output file.

At act 435, a data line is read from the tab-delimited text file.

At act 440, the data line is parsed.

At act 445, a C++ source line is generated from the parsed data line at act 440.

At act 450, the C++ source line generated at act 445 is written to the C++ output file.

At act 455, a determination step determines whether there are more data lines to be read from the tab-delimited text file. If so, the process returns to act 435, otherwise the process continues at act 460.

At act 460, the tab-delimited text file and C++ output file are closed.

At act 465, a determination step, determines whether there are any more tab-delimited text files to be processed. If so, the process returns to act 415, otherwise the process continues at act 470.

At act 470, the generated C++ source code is compiled to output a single executable 106 for delivery to the users 130.

As one example of how acts 435-445 may be implemented, reference is made again to the spreadsheet of FIG. 2a. In particular, row 2 of the spreadsheet refers to the factor “Home Health Aide Service Amount” 212. When the data line of row 2 is read from the text file (435) and parsed (440) the C++ source line generated (445) is as follows:
AddParameterName(“HHA Service Amount”,“Home Health Aide Service Amount”,“Y”,“2000-10-01”,“43.37”); (1)

The generated C++ source line is a call to a C++ function that returns a single value and includes five parameters. The first parameter, “HHA Service Amount”, is the parameter name which corresponds to the factor to be updated. The second parameter, “Home Health Aide Service Amount”, is a parameter description. The third parameter, “Y”, is the DeltaLock parameter, previously described. The fourth parameter, “2000-10-01”, is the update period corresponding to the value indicated by the fifth parameter, “43.37”, which is the parameter value to be applied to the user database 140 as the update value.

It is therefore shown that a characteristic of the executable procedure, namely, a function call including five parameters, is determined by data elements of the spreadsheet. With particular reference to the exemplary function calls of equations (1) above and (2) below, the last parameter (i.e., “43.37) may be used to determine a further characteristic of the executable procedure which may be, for example, a factor used as a multiplier in a computation formula, a constant in a computation formula, a threshold value identifying whether a computation formula is to be applied or a threshold value identifying whether a portion of the computation formula applies.

As a further example, reference is now made to the spreadsheet of FIG. 2b. In particular, row 2 of the spreadsheet refers to the “MSACode” parameter for the region Abilene, Tex. The resulting C++ source line generated in accordance with acts 435-445 is as follows:
AddMSACode(“0040”,“Abilene, Tex.”,“”,“2000-10-01”,“0.8180”); (2)

Similar to that described above, the C++ source line generated is a call to a C++ function that returns a single value and includes five parameters. The first parameter, “0040”, is the MSA code for the Abilene Tex. region, the second parameter is a text description of the region, the third parameter refers to a rural flag identifier where the null identifier, i.e., “”, is an indication of an empty condition (not a rural identifier), the fourth parameter, “2000-10-01”, is the update period, and the fifth parameter, “0.8180”, identifies the parameter value to be applied to the user database 140 as the update value.

As shown in the two examples provided above, spreadsheet data 102 is used to determine characteristics of the executable procedure 106. In the instant examples, the parsed spreadsheet data became parameter values in a C++ function call programming statement. Generally, the spreadsheet data 102 may be used to determine programming language structural features, the structure of sub-procedures in the executable procedure and a process performed by a sub-procedure in the executable procedure.

Once a user 130 has downloaded or otherwise has been delivered the executable procedure 106 of the invention, it is up to the user 130 to run the executable 106 to perform the updates to the factors in the user's database 140.

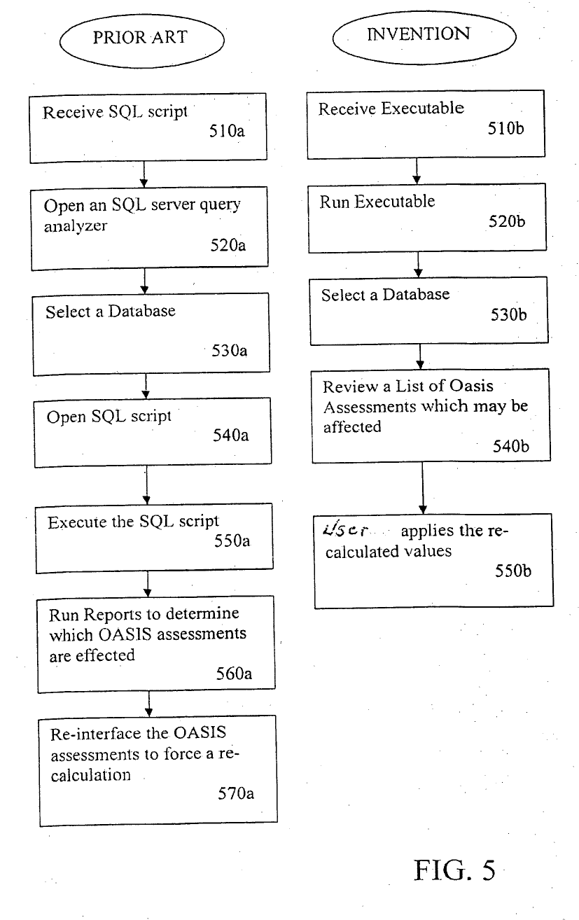

FIG. 5 describes in greater detail, act 325 of the flowchart of FIG. 3 (i.e., updating the user's database 140). FIG. 5 is constructed in such manner to illustrate, by way of comparison, the process of updating the user's database in accordance with both the present invention and the prior art. In particular, the flow diagram on the left hand side of FIG. 5 illustrates how a user 130 applies the updates to the factors to the user's database 140 in accordance with the prior art and the right hand side of FIG. 5 illustrates this same process as performed in accordance with the method of the invention. The flowcharts of FIG. 5 essentially describe in greater detail, act 325 of the flowchart of FIG. 3.

At Step 510:

(A) In accordance with the prior art approach—the users 130 receive an SQL script from the intermediary 120, which can either be downloaded over a network, such as the Internet, or delivered on a CD or other suitable medium.

(B) In accordance with the invention—the user 130 receives the executable (module) 106 which can either be downloaded over a network, such as the Internet, or delivered on a CD or other suitable medium.

At Step 520:

(A) In accordance with the prior art approach—the users 130 open an SQL Server Query Analyzer. As noted in the background, some users 130 do not possess the requisite computer skills to perform this action.

(B) In accordance with the invention—the users 130 simply runs the executable 106 with no requirement of any computer skills.

At Step 530:

(A) In accordance with the prior art approach—the user selects a database It is noted that certain users manage multiple systems (databases) and this step determines which system (database) is being addressed by the user. The same applies to part (B).

(B) In accordance with the invention—the user selects a database.

At Step 540:

(A) In accordance with the prior art approach—the users 130 open an SQL script. As noted in the background, some users do not possess the requisite computer skills to perform this action.

(B) In accordance with the invention—the user is presented with a list of OASIS assessments which could be affected. The assessment is shown to the user with both the current A/R value and the proposed recalculated A/R value.

At Step 550:

(A) In accordance with the prior art approach—The users 130 execute the SQL script.

(B) In accordance with the invention—the user applies the recalculated values. This causes the system to generate a replacement A/R in the system to which any received income may be applied.

At Step 560:

(A) In accordance with the prior art approach—the users 130 runs reports to determine which OASIS assessments were affected. The records selected by these reports indicates to the user 130 which OASIS assessments are to be manually re-processed into the system to produce the recalculated A/R. The reports provide the users 130 with information about which OASIS assessments are affected by the rate changes. It is noted that steps 560 and 570 in accordance with the prior art approach have no corollary steps in the present invention. This occurs because, in accordance with the present invention, the list of OASIS assessments affected is automatically generated by the executable and displayed to the user 130 thereby alleviating the necessity of generating reports (step 560) and having to re-interface the OASIS assessments to force a recalculation (step 570).

(B) No corollary in the present invention.

At Step 570:

(A) In accordance with the prior art approach—the users 130 re-interface or re-import the OASIS assessments into the claim generation system to force a recalculation. This process typically includes using the system in which the OASIS assessments were entered to produce a new export file to be imported, or flagging these assessments to re-interface to the claim generation application, depending upon the system used. For example, third-party OASIS Assessment software typically produces an export file which is then imported into the claim generation application. The OASIS Assessment systems produced by the claim generation software vendor have a direct interface into the claim generation system, so the assessments are simply flagged in the application to be re-interfaced.

(B) No corollary in the present invention.

As should be appreciated from the flowcharts of FIG. 5, the present invention affords the user 130 with a number of advantages over the prior art approach. The method according to the invention is considerably simpler to execute as compared with the prior art approach which demands a comparably higher degree of computer skill. Specifically, in accordance with the method of the invention there is no requirement to open an SQL script. Instead, the user 130 simply runs the executable and follows the command prompts. Further, there are fewer steps involved with the method of the invention due to the fact that there is no need to run reports (560a) or re-interface the oasis assessments (570a) to force a re-calculation.

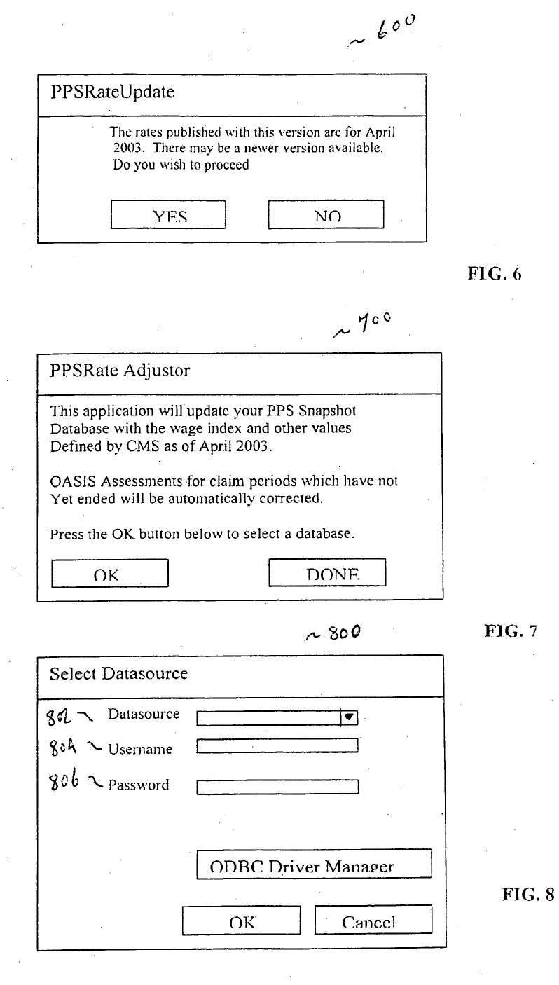

FIGS. 6-8 are display image windows shown to a user 130 which illustrate how a user 130 applies the updates to the factors to the user's database 140 in accordance with the method of the invention for the exemplary period April 2003.

Upon loading the executable procedure (.exe) 106 of the invention at the user site, the procedure 106 makes an initial check of the current system date against the latest effective date, which is the last date at which the Federal Government published updates to factors used to calculate Medicare PPS A/R amounts, and if the current system date exceeds the latest effective date by more than thirty days, the user 130 is shown a pop-up window 600 (see FIG. 6). The pop-up window 600 queries the user 130 to proceed or terminate operations at this point.

FIG. 7 is a display image window of an introductory or “home” screen 700 that is shown to a user 130 in response to the user 130 pressing the “Yes” icon in FIG. 6 or is otherwise shown at the outset of loading and running the executable procedure (.exe) 106. The display image window of FIG. 7 informs the user 130 that the user's database 140 is about to be updated with the most recently published updates to the factors published in the Federal Register. In the example shown, the updates are applicable for the period April 2003. In addition, the user 130 is informed that OASIS assessments for the current claim period is about to be automatically corrected. That is, for those OASIS assessments for which the final claim (A/R) has not yet been generated, the adjustments can be applied immediately with no additional impact on the user's workflow. In this case, the adjustments are applied automatically without the user's review.

FIG. 8 is a display image window of a datasource selection screen 800 that is shown to a user 130 in response to the user 130 pressing the “OK” icon in FIG. 7. The display image window of FIG. 8 comprises a datasource pull-down 802; by selecting a datasource from the pull-down menu, the user 130 selects which database the updates are to be applied to. The user 130 is also required to enter a username 804 and a password 806 to authenticate the user 130.

Although this invention has been described with reference to particular embodiments, it should be appreciated that many variations can be resorted to without departing from the spirit and scope of this invention as set forth in the appended claims. The specification and drawings are accordingly to be regarded in an illustrative manner and are not intended to limit the scope of the appended claims.

1. A system for generating an executable procedure, comprising:
a repository including spreadsheet representative data including stored data elements determining characteristics of an executable procedure;
an executable application for processing said spreadsheet representative data to provide an executable procedure with characteristics determined by said data elements and for use in processing data using said data elements; and
a command processor for initiating execution of said executable procedure in response to user command.

2. A system according to claim 1, wherein
said executable procedure processes data in a database using said data elements to provide updated data for storage in said database.

3. A system according to claim 1, wherein
said executable procedure characteristics determined by said data elements comprise at least one of, (a) programming language structural features, (b) structure of sub-procedures in said executable procedure and (c) a process performed by a sub-procedure in said executable procedure.

4. A system according to claim 1, wherein
said executable application processes said spreadsheet representative data to provide an executable procedure for updating a data item in a database using one of said data elements to replace a prior corresponding data element of a predetermined computation formula.

5. A system according to claim 1, wherein
said prior corresponding data element of said predetermined computation formula comprises at least one of, (a) a factor used as a multiplier in said computation formula, (b) a constant in said computation formula, (c) a threshold value identifying whether said computation formula applies, (d) a threshold value identifying whether a portion of said computation formula applies.

6. A system according to claim 1, wherein
said executable application processes said spreadsheet representative data to provide an executable procedure by updating a data item in said database by replacing said data item with one of said data elements.

7. A system according to claim 1, wherein
said executable application is a Script for generating programming language code comprising code in at least one of, (a) C++, (b) Java, (c) HTML, (d) XML and (e) SGML.

8. A system for updating data items in a database, comprising:
a repository including spreadsheet representative data including stored data elements;
an executable application for processing said spreadsheet representative data to provide an executable procedure for updating a data item in a database using one of said data elements to replace a prior corresponding data element of a predetermined computation formula to provide an updated computation formula; and
a command processor for initiating execution of said executable procedure in response to user command.

9. A system according to claim 1, wherein
said execution of said executable procedure re-computes a value of said data item using said updated computation formula and updates said data item in said database with said re-computed value.

10. A system for generating an executable procedure, comprising:
a repository including spreadsheet representative data including stored data elements;
an executable application for processing said spreadsheet representative data to provide an executable procedure for updating a data item in a database by
using one of said data elements to replace a prior corresponding data element of a predetermined computation formula to provide an updated computation formula and
re-computing a value of said data item using said updated computation formula; and
a storage processor for updating said data item in said database with said re-computed value.

11. A method for generating an executable procedure, comprising the activities of:
storing spreadsheet representative data including stored data elements determining characteristics of an executable procedure;
processing said spreadsheet representative data to provide an executable procedure with characteristics determined by said data elements and for use in processing data using said data elements; and
initiating execution of said executable procedure in response to user command.

12. A method for updating data items in a database, comprising the activities:
storing spreadsheet representative data including stored data elements;
processing said spreadsheet representative data to provide an executable procedure for updating a data item in a database using one of said data elements to replace a prior corresponding data element of a predetermined computation formula to provide an updated computation formula; and
initiating execution of said executable procedure in response to user command.

13. A method for updating data items in a database, comprising the activities of:
storing spreadsheet representative data including stored data elements;
processing said spreadsheet representative data to provide an executable procedure for updating a data item in a database;
using one of said data elements to replace a prior corresponding data element of a predetermined computation formula to provide an updated computation formula;
re-computing a value of said data item using said updated computation formula; and
updating said data item in said database with said re-computed value.
